(19) United States
(12) Patent Application Publication
(10) Pub. No.: US 2017/0113653 A1
(43) Pub. Date: Apr. 27, 2017

(54) Vehicle Security Device

(71) Applicants: Marquette Neal, Indianapolis, IN (US); Monte' Scruggs, Indianapolis, IN (US)

(72) Inventors: Marquette Neal, Indianapolis, IN (US); Monte' Scruggs, Indianapolis, IN (US)

(21) Appl. No.: 14/921,458

(22) Filed: Oct. 23, 2015

(51) Int. Cl. B60R 25/30

(52) U.S. Cl. CPC B60R 25/305

(57) ABSTRACT

A vehicle security device for vehicle security and monitoring includes a base with a plurality of feet coupled to a bottom of the base and a housing coupled to the base. A power module, a processor, a speaker, a memory storage module, a GPS receiver and a Bluetooth enabled communicator are coupled to and positioned in the housing. The processor is operationally coupled to the power module. A display, a motion sensor and a plurality of cameras are coupled to the housing. The speaker, memory storage module, GPS receiver, communicator, display and cameras are operationally coupled to the processor and the power module. A computer program, installable on the owner's electronic devices, includes software controls for the cameras, GPS receiver and the speaker.

### BACKGROUND OF THE DISCLOSURE

### Field of the Disclosure

The disclosure relates to security devices and more particularly pertains to a new security device for vehicle security and monitoring.

### SUMMARY OF THE DISCLOSURE

An embodiment of the disclosure meets the needs presented above by generally comprising a base with a plurality of feet coupled to a bottom of the base and a housing coupled to the base. A power module, a processor, a speaker, a memory storage module, a GPS receiver and a Bluetooth enabled communicator are coupled to and positioned in the housing. The processor is operationally coupled to the power module. A display, a motion sensor and a plurality of cameras are coupled to the housing. The speaker, memory storage module, GPS receiver, communicator, display and cameras are operationally coupled to the processor and the power module. A computer program, installable on the owner's electronic devices, includes software controls for the cameras, GPS receiver and the speaker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a vehicle security device according to an embodiment of the disclosure.

FIG. 2 is a left side view of an embodiment of the disclosure.

FIG. 3 is a back view of an embodiment of the disclosure.

FIG. 4 is a bottom view of an embodiment of the disclosure.

FIG. 5 is an in-use view of an embodiment of the disclosure.

FIG. 6 is a block diagram view of an embodiment of the disclosure.

### DESCRIPTION OF THE PREFERRED EMBODIMENT

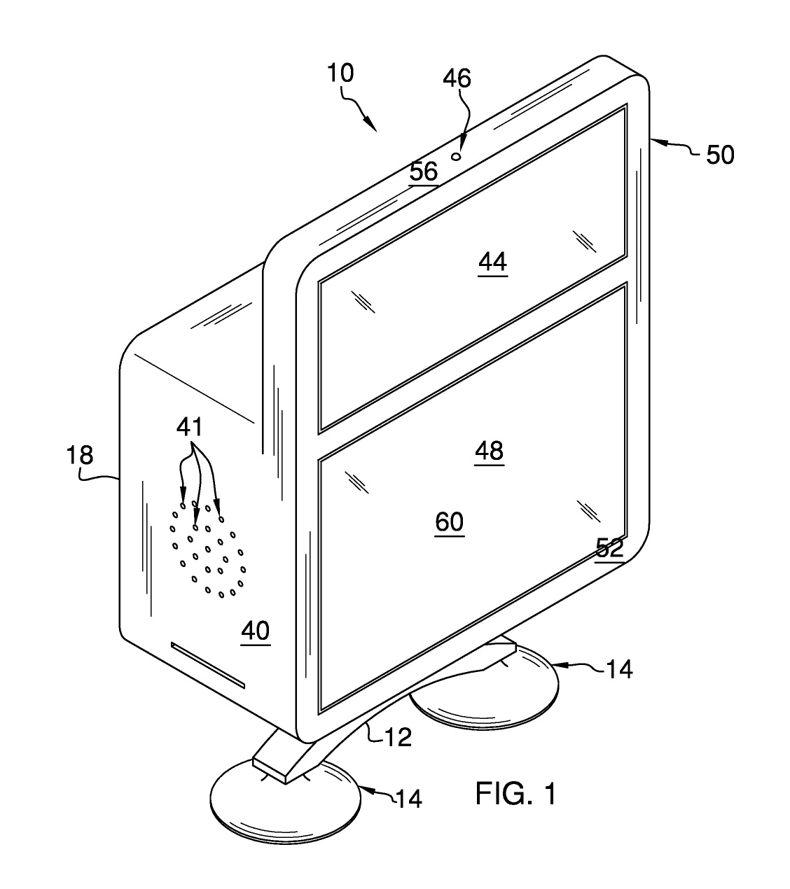

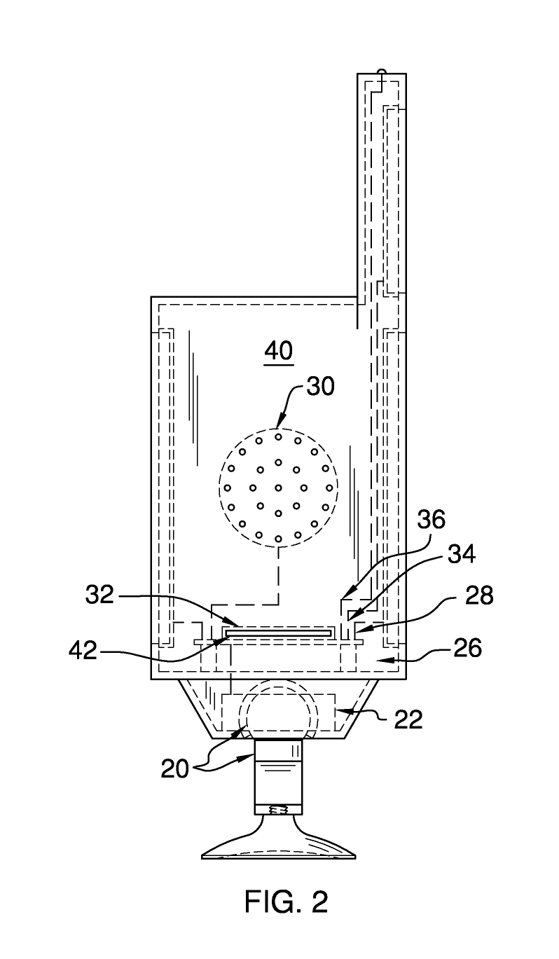

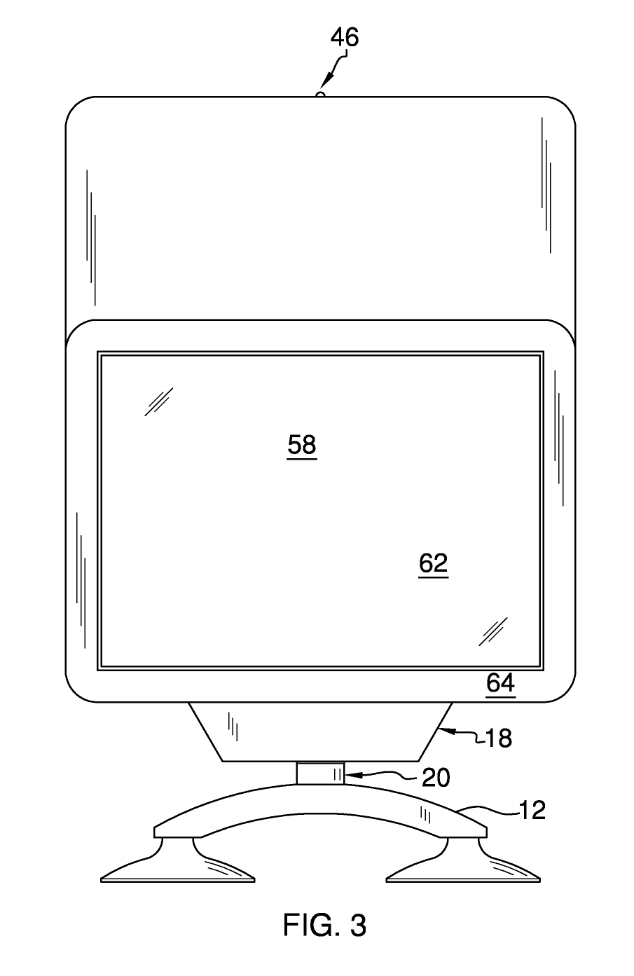

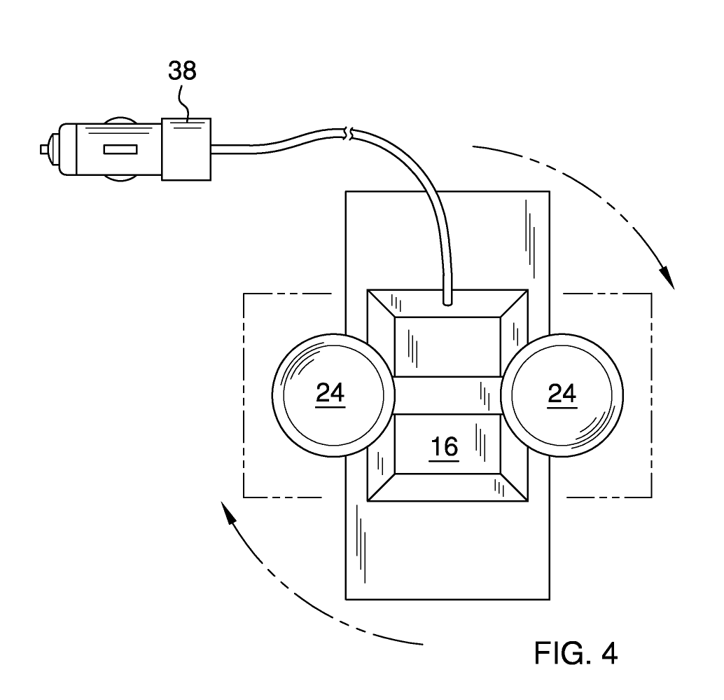

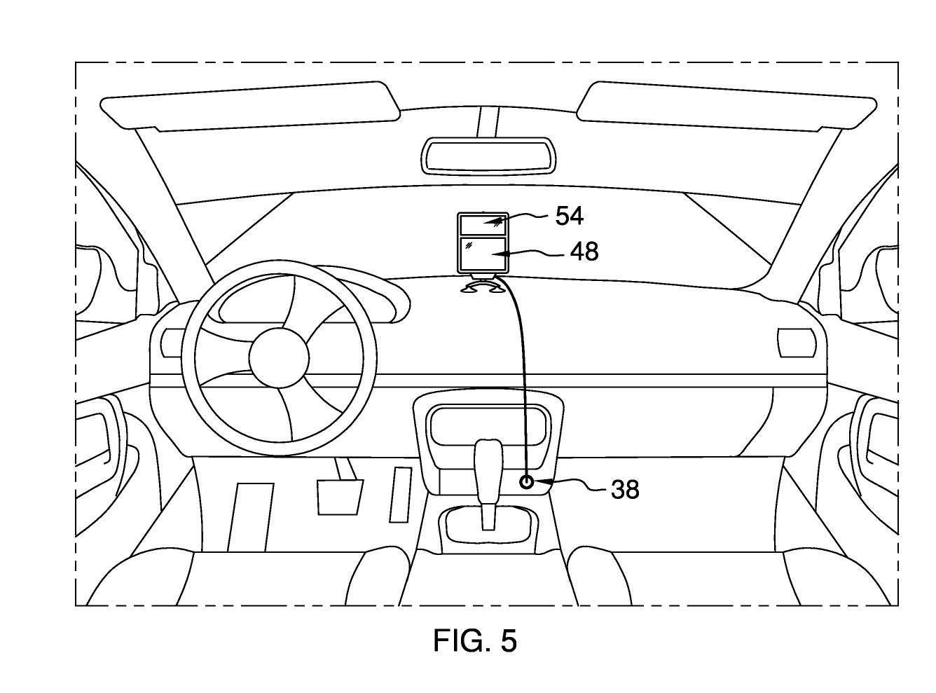

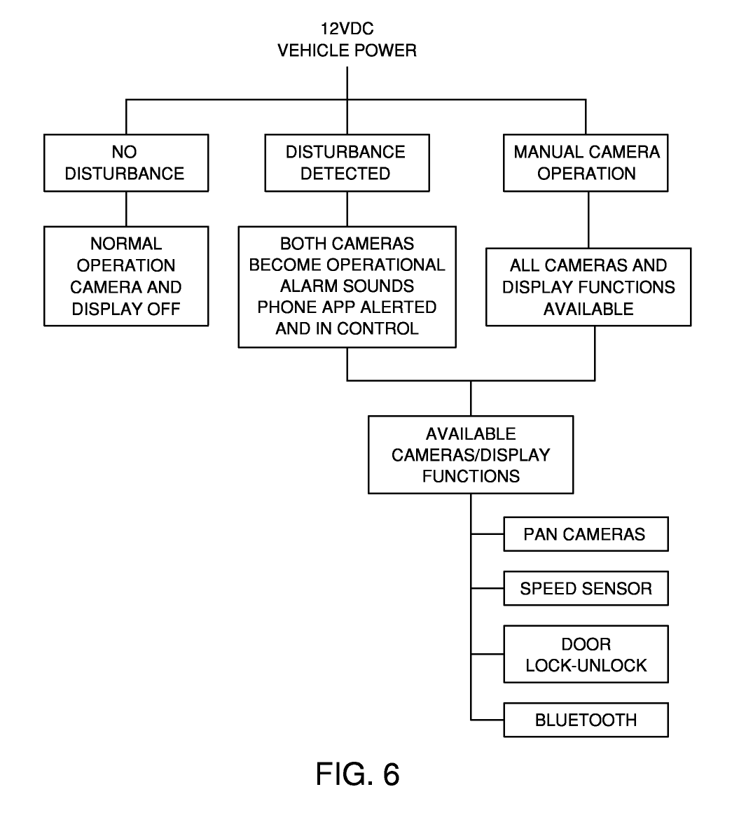

With reference now to the drawings, and in particular to FIGS. 1 through 6 thereof, a new security device embodying the principles and concepts of an embodiment of the disclosure and generally designated by the reference numeral 10 will be described.

As best illustrated in FIGS. 1 through 6, the vehicle security device 10 generally comprises a base 12 with a plurality of feet 14 coupled to a bottom 16 of the base 12 and a housing 18 rotationally coupled to the base 12. A pivot 20 is coupled to the base 12 and extends upward into the housing 18, and an actuator 22 is coupled to and positioned in the housing 18 proximate to the pivot 20. The actuator 22 is operationally coupled to the pivot 20. The plurality of feet 14 comprises two feet. The feet 14 comprise suction attachments 24.

A power module 26, a processor 28, a speaker 30, a memory storage module 32, a GPS receiver 34 and a Bluetooth enabled communicator 36 are coupled to and positioned in the housing 18. The processor 28 is operationally coupled to the power module 26. The power module 26 comprises a 12 volt accessory outlet plug 38. The speaker 30 is coupled to a left side 40 of the housing 18 proximate to a plurality of penetrations 41 positioned in the left side 40. The memory storage module 32 comprises a memory card writer 42. The communicator 36 is capable of sending and receiving data over cellular and wireless local area networks.

A display 44, a motion sensor 46 and a plurality of cameras 48 are coupled to the housing 18. The display 44 is coupled to an upward extension 50 of a front 52 of the housing 18. The display 44 is a liquid crystal display 54. The motion sensor 46 is coupled to a top surface 56 of the upward extension 50. The plurality of cameras 48 comprises infrared cameras 58. The plurality of cameras 48 comprises a first camera 60 coupled to the front 52 and second camera 62 coupled to a back 64 of the housing 18. The speaker 30, memory storage module 32, GPS receiver 34, communicator 36, display 44 and cameras 48 are operationally coupled to the processor 28 and the power module 26.

A computer program, installable on the owner's electronic devices, includes software controls for the cameras 48, GPS receiver 34, the actuator 22 and the speaker 30.

In use, the device 10 is positionable in a vehicle for security and monitoring purposes. The motion sensor 46 can be activated by the user, wherein motion in or around the vehicle will be detected by the motion sensor 46, activating the plurality of cameras 48 and the GPS receiver 34. A notification, GPS location and speed information, along with images of the vehicle interior and exterior surroundings captured by the plurality of cameras 48, are sent via the communicator 36 to the electronic devices of the user. The user can use the computer program to control the function of the cameras 48, the GPS receiver 34, the speaker 30 and the actuator 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle security device comprising:
a base, said base having a plurality of feet coupled to a bottom of said base;
a housing, said housing being coupled to said base;
a power module, said power module being coupled to and positioned in said housing;
a processor, said processor being coupled to and positioned in said housing, said processor being operationally coupled to said power module;
a display, said display being coupled to said housing, said display being operationally coupled to said processor and said power module;
a motion sensor, said motion sensor being coupled to said housing, said motion sensor being operationally coupled to said processor and said power module;
a plurality of cameras, said cameras being coupled to said housing, said cameras being operationally coupled to said processor and said power module;
a speaker, said speaker being coupled to and positioned in said housing, said speaker being operationally coupled to said processor and said power module;
a memory storage module, said memory storage module being coupled to and positioned in said housing, said memory storage module being operationally coupled to said processor and said power module;
a GPS receiver, said GPS receiver being coupled to and positioned in said housing, said GPS receiver being operationally coupled to said processor and said power module;
a communicator, said communicator being coupled to and positioned in said housing, said communicator being operationally coupled to said processor and said power module, said communicator being Bluetooth enabled; and
a computer program, said program being installable on the owner's electronic devices, said program including software controls for said cameras, said GPS receiver and said speaker.

2. The device of claim 1, further including said housing being rotationally coupled to said base.

3. The device of claim 1, further comprising:
a pivot, said pivot being coupled to said base and extending upward into said housing;
an actuator, said actuator being coupled to and positioned in said housing proximate to said pivot, said actuator being operationally coupled to said pivot, said processor and said power module; and
wherein said actuator is positioned to engage said pivot to rotate said housing relative to said base.

4. The device of claim 1, further including said plurality of feet comprising two feet.

5. The device of claim 1, further including said feet comprising suction attachments, wherein said suction attachments are positioned on said base for coupling to the dash of a vehicle.

6. The device of claim 1, further including said power module comprising a 12 volt accessory outlet plug.

7. The device of claim 1, further including said display being coupled to an upward extension of a front of said housing.

8. The device of claim 1, further including said display being a liquid crystal display.

9. The device of claim 7, further including said motion sensor being coupled to a top surface of said upward extension.

10. The device of claim 1, further including said plurality of cameras comprising infrared cameras.

11. The device of claim 1, further including said plurality of cameras comprising a first camera coupled to said front and second camera coupled to a back of said housing.

12. The device of claim 1, further including said speaker being coupled to a left side of said housing proximate to a plurality of penetrations positioned in said left side.

13. The device of claim 1, further including said memory storage module comprising a memory card writer.

14. The device of claim 1, further including said communicator being capable of sending and receiving data over cellular and wireless local area networks.

15. A vehicle security device comprising:
a base, said base having a plurality of feet coupled to a bottom of said base, said plurality of feet comprising two feet, said feet comprising suction attachments, wherein said suction attachments are positioned on said base for coupling to the dash of a vehicle;
a housing, said housing being coupled to said base, said housing being rotationally coupled to said base;
a power module, said power module being coupled to and positioned in said housing, said power module comprising a 12 volt accessory outlet plug;
a processor, said processor being coupled to and positioned in said housing, said processor being operationally coupled to said power module;
a display, said display being coupled to said housing, said display being operationally coupled to said processor and said power module, said display being coupled to an upward extension of a front of said housing, said display being a liquid crystal display;
a motion sensor, said motion sensor being coupled to said housing, said motion sensor being operationally coupled to said processor and said power module, said motion sensor being coupled to a top surface of said upward extension;
a plurality of cameras, said cameras being coupled to said housing, said cameras being operationally coupled to said processor and said power module, said plurality of cameras comprising infrared cameras, said plurality of cameras comprising a first camera coupled to said front and second camera coupled to a back of said housing;
a speaker, said speaker being coupled to and positioned in said housing, said speaker being operationally coupled to said processor and said power module, said speaker being coupled to a left side of said housing proximate to a plurality of penetrations positioned in said left side;
a memory storage module, said memory storage module being coupled to and positioned in said housing, said memory storage module being operationally coupled to said processor and said power module; said memory storage module comprising a memory card writer;
a GPS receiver, said GPS receiver being coupled to and positioned in said housing, said GPS receiver being operationally coupled to said processor and said power module, wherein said GPS receiver is enabled to receive signals from the global positioning system and can relay time and coordinate data to said processor;
a communicator, said communicator being coupled to and positioned in said housing, said communicator being operationally coupled to said processor and said power module, said communicator being Bluetooth enabled, said communicator being capable of sending and receiving data over cellular and wireless local area networks, wherein said communicator is enabled to receive audio and visual signals via said processor and to relay those signals to the user, and wherein said communicator is enabled to receive commands from the user and relay those commands for execution by said processor;
a pivot, said pivot being coupled to said base and extending upward into said housing;
an actuator, said actuator being coupled to and positioned in said housing proximate to said pivot, said actuator being operationally coupled to said pivot, said processor and said power module, wherein said actuator is positioned to engage said pivot to rotate said housing relative to said base;
a computer program, said program being installable on the owner's electronic devices, said program including software controls for said cameras, said GPS receiver, said speaker, and said actuator, wherein said program can be utilized by the owner to control the function of said cameras, said GPS receiver, said speaker and said actuator and wherein the owner's devices may include laptop, tablet, and desktop computers and cellphones; and
wherein said device is positionable in a vehicle for security and monitoring purposes, wherein said motion sensor can be activated by the user, motion in or around the vehicle will be detected by said motion sensor, activating said plurality of cameras and said GPS receiver, such that a notification, GPS location and speed information, along with images of the vehicle interior and exterior surroundings are sent to the electronic devices of the user.
